(19) United States
(12) Patent Application Publication
(10) Pub. No.: US 2026/0127369 A1
(43) Pub. Date: May 7, 2026

(54) UTILIZING A MULTI-ENCODER MULTIMODAL LANGUAGE MODEL ARCHITECTURE TO ENHANCE READING ABILITY IN GENERATING QUERY RESPONSES FROM TEXTUAL CONTENT IN DIGITAL IMAGES

(71) Applicant: Adobe Inc., San Jose, CA (US)

(72) Inventors: Ruiyi Zhang, San Jose, CA (US); Yufan Zhou, Buffalo, NY (US); Jian Chen, Getzville, NY (US); Jiuxiang Gu, College Park, MD (US); Tong Sun, San Jose, CA (US)

(21) Appl. No.: 18/940,029

(22) Filed: Nov. 7, 2024

(51) Int. Cl. G06F 40/284; G06F 40/205; G06V 10/44; G06V 10/80

(52) U.S. Cl. CPC G06F 40/284; G06F 40/205; G06V 10/44; G06V 10/806

(57) ABSTRACT

The present disclosure relates to systems, non-transitory computer-readable media, and methods for reading text within digital images utilizing multimodal language models. In particular, in some embodiments, the disclosed systems generate, utilizing a first visual encoder, a first set of visual features of a digital image comprising text. In addition, in some embodiments, the disclosed systems generate, utilizing a second visual encoder, a second set of visual features of the digital image. Moreover, in some embodiments, the disclosed systems determine, utilizing a visual-text encoder, a text string corresponding to the text of the digital image. Furthermore, in some embodiments, the disclosed systems generate, for a query directed to the text of the digital image, a response from the first set of visual features, the second set of visual features, and the text string utilizing a large language model.

### BACKGROUND

Recent years have seen developments in hardware and software platforms implementing vision models for reading text within digital images. For example, existing systems utilize large language models to understand and manipulate digital images. Despite these developments, existing systems suffer from a number of technical deficiencies, including inaccuracy and inefficiency. Indeed, many existing systems struggle with comprehending intensive textual content embedded within images, primarily due to the limited text recognition and layout understanding ability of implementing models.

### BRIEF SUMMARY

Embodiments of the present disclosure provide benefits and/or solve one or more problems in the art with systems, non-transitory computer-readable media, and methods for utilizing a multi-encoder multimodal language model architecture to enhance model reading ability in generating query responses from textual content in digital images. In particular, in some embodiments, the disclosed systems utilize a multimodal large language model that utilizes dual visual encoders along with a visual text encoder that enables efficient extraction of visual texts. For example, the disclosed systems generate a first set of visual features of a digital image utilizing a high-resolution visual encoder and a second set of visual features of the digital image utilizing a low-resolution visual encoder. Additionally, in some implementations, the disclosed systems determine text strings corresponding to text depicted in the digital image, utilizing a visual-text encoder. Moreover, in some embodiments, the disclosed systems tokenize the visual features and the text strings, as well as a user query directed to the text. Furthermore, in some implementations, the disclosed systems prompt a large language model with the tokens for the visual features, text strings, and user query to generate a response to the user query.

In addition, in some embodiments, the disclosed systems train one or more machine learning models used to generate the responses to the queries. For instance, in some implementations, the disclosed systems pretrain a projection layer that tokenizes the visual features according to one or more feature alignment tasks. Moreover, in some embodiments, the disclosed systems finetune the projection layer and the large language model for prompt instruction to enhance accuracy of response generation. By utilizing a multi-encoder multimodal large language model architecture and/or layout-aware pretraining and instruction finetuning, the disclosed systems demonstrate substantial enhancements in text-rich image understanding, surpassing multiple baselines on public benchmarks.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a multimodal reading system operates in accordance with one or more embodiments.

FIG. 2 illustrates the multimodal reading system parsing text from a digital image and responding to a query directed to the text in accordance with one or more embodiments.

FIG. 3 illustrates the multimodal reading system extracting textual information from a digital image and generating a query response about the textual information in accordance with one or more embodiments.

FIG. 4A-4C illustrate the multimodal reading system pretraining a projection layer in accordance with one or more embodiments.

FIG. 5 illustrates the multimodal reading system finetuning a projection layer and a large language model in accordance with one or more embodiments.

FIG. 6 illustrates the multimodal reading system reading a text-rich digital image and answering a question directed to the text of the digital image in accordance with one or more embodiments.

FIG. 7 illustrates experimental results of the multimodal reading system, with comparisons to existing systems, in accordance with one or more embodiments.

FIG. 8 illustrates a diagram of an example architecture of the multimodal reading system in accordance with one or more embodiments.

FIG. 9 illustrates a flowchart of a series of acts for reading text within a digital image and generating a response to a query directed to the text within the digital image in accordance with one or more embodiments.

FIG. 10 illustrates a block diagram of an example computing device for implementing one or more embodiments of the present disclosure.

### DETAILED DESCRIPTION

This disclosure describes one or more embodiments of a multimodal reading system that utilizing a multi-encoder multimodal language model architecture to enhance model reading ability in generating query responses from textual content in digital images. To illustrate, the multimodal reading system utilizes a high-resolution visual encoder and a low-resolution visual encoder to efficiently capture visual information of a digital image. Additionally, the multimodal reading system utilizes a lightweight visual-text encoder to extract text of a digital image. In some embodiments, the multimodal reading system tokenizes the visual features and the text, as well as a user query directed to the text. Furthermore, the multimodal reading system prompts a large language model with the tokens for the visual features, text strings, and user query to generate a response to the user query. By utilizing a model architecture with multiple visual encoders, the multimodal reading system enables improved extraction and interpretation of visual texts from digital images.

Moreover, in some embodiments, the multimodal reading system trains one or more machine learning models used to generate the responses to the queries utilizing various layout-aware and finetuning tasks to enhance alignment and collaboration among multiple visual encoders. For instance, the multimodal reading system pretrains a projection layer that tokenizes the visual features according to one or more feature alignment tasks. In some embodiments, the multimodal reading system finetunes the projection layer and the large language model for prompt instruction following to enhance accuracy of response generation.

Although existing systems can identify and read text within digital images, such systems have a number of problems in relation to accuracy and efficiency. For instance, many existing systems struggle with visual text understanding tasks, and thus often produce inaccurate results. Moreover, existing systems have limited proficiency in comprehending large amounts of textual content within a text-rich image. For example, many existing models struggle with comprehending intensive textual contents embedded within images, primarily due to their limited text recognition and layout understanding ability.

In addition, existing systems suffer from inefficiency. For example, some existing systems use a large classical visual encoder that requires extensive computational expense to extract visual texts. While not only suffering from inaccuracy of text extraction, the large visual encoder employed by some existing systems also comes with a high computing burden (e.g., excessive computations, bandwidth used, memory used, etc.).

The multimodal reading system provides a variety of technical advantages relative to existing systems. For example, by utilizing dual visual encoders along with a visual-text encoder, the multimodal reading system improves the reading ability of multimodal language models, thereby enhancing accuracy relative to existing systems. For instance, the multimodal reading system improves the text-rich image understanding by simultaneously accomplishing both visual objects and visual texts understanding. Moreover, by coupling layout-aware pretraining with instruction finetuning, the multimodal reading system demonstrates substantial enhancements in text-rich image understanding, surpassing multiple baselines on public benchmarks.

In addition, the multimodal reading system enhances efficiency over existing systems. For example, by using multiple visual encoders and a light-weight visual-text encoder, the multimodal reading system enables efficient extraction of visual texts from text-rich digital images. In particular, by focusing the dual visual encoders on processing visual objects, while the light-weight visual-text encoder focuses on extracting text within images, the multimodal reading system enhances the efficiency of the visual components, as text recognition presents distinct patterns compared to visual object detection. Furthermore, in some embodiments, the multimodal reading system merges the outputs of the two visual encoders while maintaining the same visual tokens, thereby mitigating potential additional computational costs from having two visual encoders.

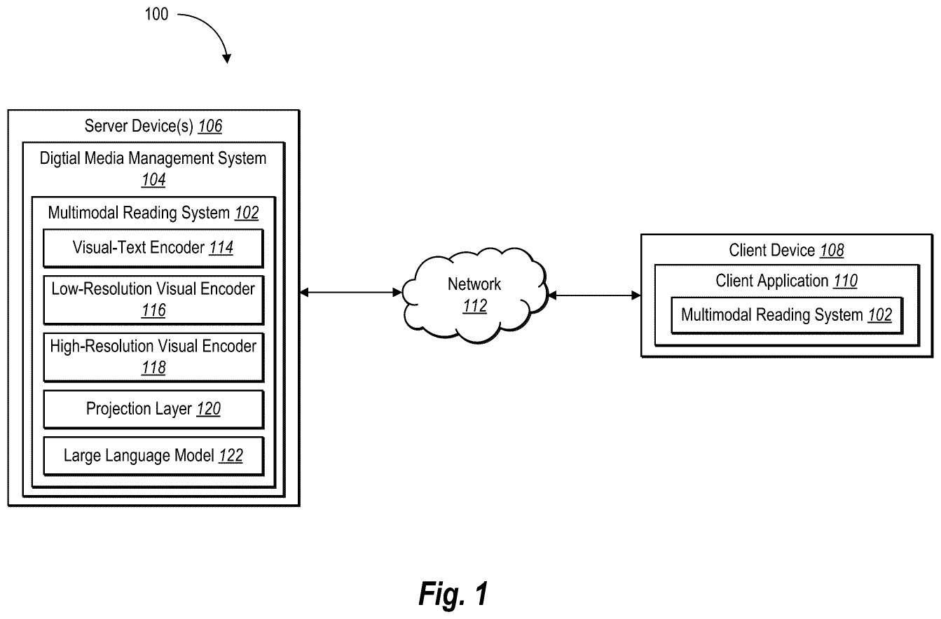

Additional detail will now be provided in relation to illustrative figures portraying example embodiments and implementations of a multimodal reading system. For example, FIG. 1 illustrates a system 100 (or environment) in which a multimodal reading system 102 operates in accordance with one or more embodiments. As illustrated, the system 100 includes server device(s) 106, a network 112, and a client device 108. As further illustrated, the server device(s) 106 and the client device 108 communicate with one another via the network 112.

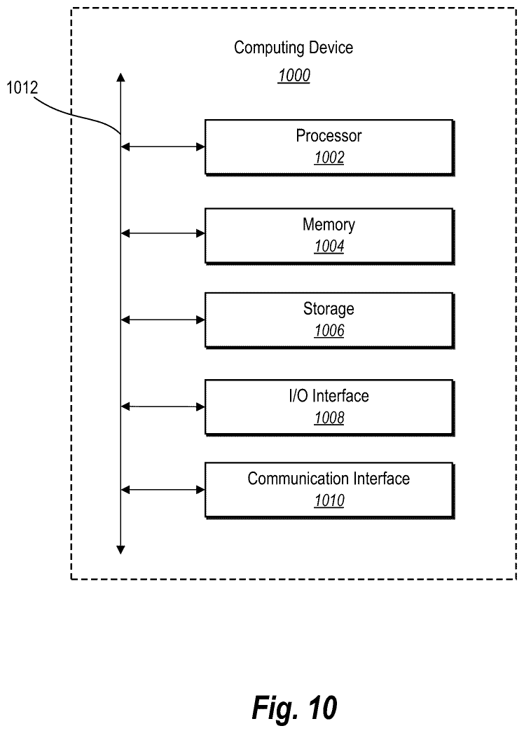

As shown in FIG. 1, the server device(s) 106 includes a digital media management system 104 that further includes the multimodal reading system 102. In some embodiments, the multimodal reading system 102 utilizes one or more machine learning models (e.g., a visual-text encoder 114, a low-resolution visual encoder 116, a high-resolution visual encoder 118, a projection layer 120, and/or a large language model 122) to read text within an image and generate responses to user queries about the text in the image. For example, in some implementations, the multimodal reading system 102 utilizes the machine learning models to generate tokens for visual features of the image, to generate tokens for text within the image, and to generate linguistic responses to queries based on the tokens. In some embodiments, the server device(s) 106 includes, but is not limited to, a computing device (such as explained below with reference to FIG. 10).

A machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof.

Similarly, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer, or a generative adversarial neural network.

Relatedly, a large language model includes a machine learning model trained to perform computer tasks to generate or identify patterns in textual content in response to trigger events (e.g., user interactions, such as text queries). In particular, a large language model can be a neural network (e.g., a deep neural network having a transformer architecture) with many parameters trained on large quantities of data (e.g., unlabeled text) using a particular learning technique (e.g., self-supervised learning). For example, a large language model can include parameters trained to generate or identify patterns in textual content based on various contextual data, including information from a large corpus of linguistic content.

In some instances, the multimodal reading system 102 receives a request (e.g., from the client device 108) to read text from a digital image and/or respond to a query about the text within the digital image. For example, the multimodal reading system 102 obtains the digital image and receives a request to read and analyze text within the digital image, such as by generating a response to a user query directed to the text within the digital image. Some embodiments of server device(s) 106 perform a variety of functions via the digital media management system 104 on the server device(s) 106. To illustrate, the server device(s) 106 (through the multimodal reading system 102 on the digital media management system 104) performs functions such as, but not limited to, generating a set of visual features for a digital image, generating visual tokens from the set of visual features, determining text information for text within the digital image, generating text tokens for the text information, and generating a response for a query directed to the text based on the visual tokens and the text tokens. In some embodiments, the server device(s) 106 utilizes the visual-text encoder 114 to determine the text information, the low-resolution visual encoder 116 and the high-resolution visual encoder 118 to generate the set of visual features, the projection layer 120 to generate the visual tokens, and the large language model 122 to generate the response. In some embodiments, the server device(s) 106 trains one or more of these machine learning models, such as the projection layer 120 and/or the large language model 122.

Furthermore, as shown in FIG. 1, the system 100 includes the client device 108. In some embodiments, the client device 108 includes, but is not limited to, a mobile device (e.g., a smartphone, a tablet), a laptop computer, a desktop computer, or any other type of computing device, including those explained below with reference to FIG. 10. Some embodiments of client device 108 perform a variety of functions via a client application 110 on client device 108. For example, the client device 108 (through the client application 110) performs functions such as, but not limited to, generating a set of visual features for a digital image, generating visual tokens from the set of visual features, determining text information for text within the digital image, generating text tokens for the text information, and generating a response for a query directed to the text based on the visual tokens and the text tokens. In some embodiments, the client device 108 utilizes the visual-text encoder 114 to determine the text information, the low-resolution visual encoder 116 and the high-resolution visual encoder 118 to generate the set of visual features, the projection layer 120 to generate the visual tokens, and the large language model 122 to generate the response. In some embodiments, the client device 108 trains one or more of these machine learning models, such as the projection layer 120 and/or the large language model 122.

To access the functionalities of the multimodal reading system 102 (as described above and in greater detail below), in one or more embodiments, a user interacts with the client application 110 on the client device 108. For example, the client application 110 includes one or more software applications (e.g., to parse digital images, extract text from digital images, and/or respond to queries about the text in the digital images in accordance with one or more embodiments described herein) installed on the client device 108, such as a digital media management application, a multimodal reading application, and/or an image parsing application. In certain instances, the client application 110 is hosted on the server device(s) 106. Additionally, when hosted on the server device(s) 106, the client application 110 is accessed by the client device 108 through a web browser and/or another online interfacing platform and/or tool. Furthermore, in some embodiments, the client device 108, the server device(s) 106, or another system host one or more databases including digital data.

As illustrated in FIG. 1, in some embodiments, the multimodal reading system 102 is hosted by the client application 110 on the client device 108 (e.g., additionally, or alternatively to being hosted by the digital media management system 104 on the server device(s) 106). For example, the multimodal reading system 102 performs the image-text reading and analysis techniques described herein on the client device 108. In some implementations, the multimodal reading system 102 utilizes the server device(s) 106 to train and implement machine learning models (such as the projection layer 120 and/or the large language model 122). In one or more embodiments, the multimodal reading system 102 utilizes the server device(s) 106 to train machine learning models (such as the projection layer 120 and/or the large language model 122) and utilizes the client device 108 to implement or apply the machine learning models.

Further, although FIG. 1 illustrates the multimodal reading system 102 being implemented by a particular component and/or device within the system 100 (e.g., the server device(s) 106 and/or the client device 108), in some embodiments the multimodal reading system 102 is implemented, in whole or in part, by other computing devices and/or components in the system 100. For instance, in some embodiments, the multimodal reading system 102 is implemented on another client device. More specifically, in one or more embodiments, the description of (and acts performed by) the multimodal reading system 102 are implemented by (or performed by) the client application 110 on another client device.

In some embodiments, the client application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106 (e.g., a request to parse text from a digital image and provide a response to a query directed to the text). In response, the multimodal reading system 102 on the server device(s) 106 performs operations described herein to generate visual features, determine text information, and generate a response for the query according to the request. The server device(s) 106 provides the output or results of the operations (e.g., the response) to the client device 108. As another example, in some implementations, the multimodal reading system 102 on the client device 108 performs operations described herein to generate visual features, determine text information, and generate a response for the query according to the request. The client device 108 provides the output or results of the operations (e.g., the response) via a display of the client device 108, and/or transmits the output or results of the operations to another device (e.g., the server device(s) 106 and/or another client device).

Additionally, as shown in FIG. 1, the system 100 includes the network 112. As mentioned above, in some instances, the network 112 enables communication between components of the system 100. In certain embodiments, the network 112 includes a suitable network and communicates using any communication platforms and technologies suitable for transporting data and/or communication signals, examples of which are described with reference to FIG. 10. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

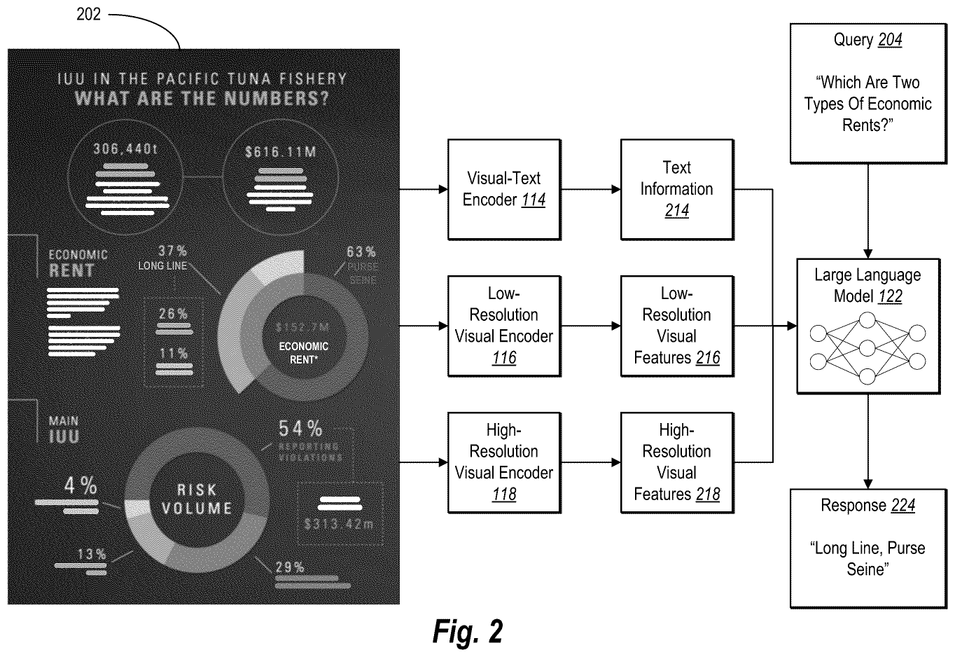

As mentioned, in some embodiments, the multimodal reading system 102 reads text from digital images and responds to queries about the text. For instance, FIG. 2 illustrates the multimodal reading system 102 parsing text from a digital image and responding to a query directed to the text in accordance with one or more embodiments.

Specifically, FIG. 2 shows the multimodal reading system 102 obtaining a digital image 202 and using machine learning models to parse text from the digital image 202. In some embodiments, the multimodal reading system 102 parses text-rich digital images, such as posters, book covers, advertisements, pamphlets, infographics, flyers, and/or educational documents. In the example shown in FIG. 2, the digital image 202 is an infographic containing text about Pacific tuna fishing.

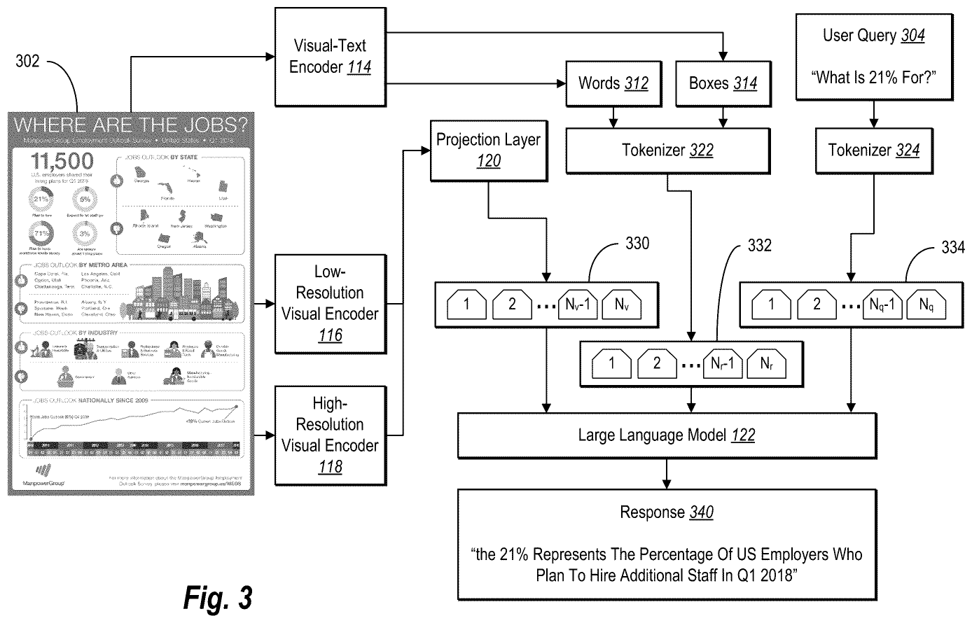

Moreover, FIG. 2 shows the multimodal reading system 102 utilizing a visual-text encoder 114 to determine text information 214 from the digital image 202. For example, the multimodal reading system 102 extracts text (e.g., characters, words, sentences, etc.) from the digital image 202 using the visual-text encoder 114. For instance, as discussed in additional detail below in connection with FIG. 3, the multimodal reading system 102 generates one or more text strings representing the text depicted in the digital image 202. Additionally, in some embodiments, the multimodal reading system 102 determines text location information for the text. For example, the multimodal reading system 102 determines positions of the text within the digital image 202, such as bounding boxes that represent beginning positions and ending positions of the text.

A visual-text encoder includes a computer-implemented model (e.g., a machine learning model, such as a neural network, or a heuristic model) that identifies visual text within an image and matches the visual text with textual information to represent the visual text (e.g., character strings, location information, etc.). For example, a visual-text encoder includes an encoder that converts image text to a numerical representation (e.g., in a vector representation space).

Additionally, FIG. 2 shows the multimodal reading system 102 utilizing a low-resolution visual encoder 116 to generate low-resolution visual features 216 for the digital image 202. Moreover, FIG. 2 shows the multimodal reading system 102 utilizing a high-resolution visual encoder 118 to generate high-resolution visual features 218 for the digital image 202. A visual encoder includes a machine learning model, such as a neural network, that identifies visual objects within an image and discerns features of the visual objects. For example, a visual encoder includes an encoder that converts a visual object to a numerical representation (e.g., in a vector representation space). Visual features include numerical representations of features of an image (e.g., features and/or pixels of a digital image). For instance, in some cases, a visual feature includes a feature map or feature vector representation of a digital image. To illustrate, visual features include a latent feature vector representation of a digital image generated by one or more layers of a neural network (such as a visual encoder).

Furthermore, FIG. 2 shows the multimodal reading system 102 obtaining a query 204. For example, the multimodal reading system 102 receives or accesses the query 204 via a user input of a client device that asks for information about the text within the digital image 202. In some cases, the query 204 is a question about the textual content of the digital image 202.

As mentioned, in some embodiments, the multimodal reading system 102 utilizes the large language model 122 to respond to queries. For example, FIG. 2 shows the multimodal reading system 102 processing the query 204 through the large language model 122 to generate a response 224. Additionally, as shown, the multimodal reading system 102 processes the text information 214, the low-resolution visual features 216, and the high-resolution visual features 218 through the large language model 122 to generate the response 224. In the example shown, the query 204 asks “Which are two types of economic rents?” (in reference to the Pacific tuna fishing infographic shown as the digital image 202). The multimodal reading system 102 parses the text of the infographic to generate the response 224 of “long line, purse seine” in answer to the query 204.

As discussed, in some embodiments, the multimodal reading system 102 parses digital images to discern textual information within the digital images. For instance, FIG. 3 illustrates the multimodal reading system 102 extracting textual information from a digital image and generating a query response about the textual information in accordance with one or more embodiments.

Specifically, FIG. 3 shows the multimodal reading system 102 accessing a digital image 302. In some embodiments, the multimodal reading system 102 determines text information corresponding to text of the digital image 302 utilizing the visual-text encoder 114. For instance, the multimodal reading system 102 determines a text string (e.g., words 312) corresponding to the text of the digital image 302. In some embodiments, the multimodal reading system 102 uses an optical character recognition (OCR) tool for the visual-text encoder 114.

In addition, in some embodiments, the multimodal reading system 102 determines text location information for the text string utilizing the visual-text encoder 114. For example, the multimodal reading system 102 determines bounding boxes 314 that represent positions of the text string (e.g., a beginning position and an ending position). By using the visual-text encoder 114 to capture textual and layout information for the digital image 302, the multimodal reading system 102 enhances reading ability of the multimodal language model over existing multimodal systems.

Moreover, in some embodiments, the multimodal reading system 102 generates text tokens for the text of the digital image 302. For instance, the multimodal reading system 102 utilizes a text tokenizer 322 to generate text tokens 332 for the words 312 and bounding boxes 314. In some embodiments, the multimodal reading system 102 utilizes an OCR tokenizer to tokenize the text of the digital image 302. For example, the multimodal reading system 102 encodes the words 312 and the bounding boxes 314.

To illustrate, in some implementations, the tokenizer comprises a layout recovery module and a large language model tokenizer. Upon receiving text results (e.g., OCR results) from a text-rich image, the multimodal reading system 102 utilizes a layout recovery model to process the input by inserting spaces and line breaks. In some embodiments, the layout recovery process follows a heuristic approach. In particular, the multimodal reading system 102 identifies text boxes in the same row with detected words and rearranges them in a top-to-bottom and left-to-right order based on their coordinates. In addition, the multimodal reading system 102 calculates the average character width for each row based on its width and word count. The multimodal reading system 102 then inserts placeholders based on the horizontal distance between two text boxes in the same row, resulting in the extraction of single-row texts. Moreover, the multimodal reading system 102 inserts newline characters for each row, reconstructing the page layout. In some implementations, the multimodal reading system 102 utilizes the plain text with layout information as part of large language model prompts in both training and inference.

As mentioned, in some embodiments, the multimodal reading system 102 generates visual features for the digital image 302. For example, the multimodal reading system 102 generates low-resolution visual features for the digital image 302 utilizing the low-resolution visual encoder 116, and high-resolution visual features for the digital image 302 utilizing the high-resolution visual encoder 118. To illustrate, the multimodal reading system 102 generates the low-resolution visual features by generating visual features that have a lower resolution than the high-resolution visual features. Stated otherwise, the high-resolution visual features have a higher resolution than the low-resolution visual features. In some embodiments, for the low-resolution visual encoder 116, the multimodal reading system 102 utilizes a vision-transformer-based encoder (e.g., at 336×336 resolution) that focuses on global visual information. In some embodiments, for the high-resolution visual encoder 118, the multimodal reading system 102 utilizes a convolution-based encoder (e.g., at 768×768 resolution) that focuses on visual details.

Moreover, in some embodiments, the multimodal reading system 102 combines the high-resolution visual features and the low-resolution visual features into a set of combined visual features for the digital image 302. For instance, the multimodal reading system 102 uses the high-resolution visual encoder 118 to merge its information into the low-resolution visual encoder 116. To illustrate, the multimodal reading system 102 combines the outputs of two fully connected layers, one for the high-resolution visual encoder 118 and one for the low-resolution visual encoder 116. Thus, the multimodal reading system 102 merges features that have the same size.

Furthermore, in some implementations, the multimodal reading system 102 utilizes the projection layer 120 to generate visual tokens 330 from the set of combined visual features for the digital image 302. For instance, the projection layer 120 includes a multi-layer perceptron (MLP) projection to transform the visual features into visual tokens for the large language model 122. In some embodiments, the multimodal reading system 102 utilizes the projection layer 120 to generate the visual tokens 330 having the same embedding dimensions as the text tokens generated by the tokenizer 322.

As also mentioned, in some implementations, the multimodal reading system 102 obtains a user query 304. For instance, the multimodal reading system 102 receives the user query 304 as a user input from client device 108. In the example shown in FIG. 3, the user query 304 asks “what s 21% for?”in reference to the text of the infographic of digital image 302.

In some embodiments, the multimodal reading system 102 generates tokens for the user query 304. For example, the multimodal reading system 102 utilizes a text tokenizer 324 to generate query tokens 334 for the user query 304. In some embodiments, the text tokenizer 324 is the same as the text tokenizer 322. By contrast, in some embodiments, the text tokenizer 324 is a different tokenizer from the text tokenizer 322.

As discussed, in some embodiments, the multimodal reading system 102 generates a response to the user query 304. For example, the multimodal reading system 102 utilizes the large language model 122 to generate a response 340 for the user query 304 based on the visual features and the text extracted from the digital image 302. To illustrate, the multimodal reading system 102 processes the visual tokens 330, the text tokens 332, and the query tokens 334 through the large language model 122 to generate the response 340. For instance, the multimodal reading system 102 prompts the large language model 122 with the visual tokens 330, the text tokens 332, and the query tokens 334 to generate the response 340 for the query 304. In some embodiments, the multimodal reading system 102 concatenates the visual tokens 330, the text tokens 332, and the query tokens 334 before processing them through the large language model 122 to generate the response 340. In the example shown in FIG. 3, the multimodal reading system 102 generates the response 340 to read “the 21% represents the percentage of US employers who plan to hire additional staff in Q1 2018,”in response to “what is 21% for? ”in the user query 304.

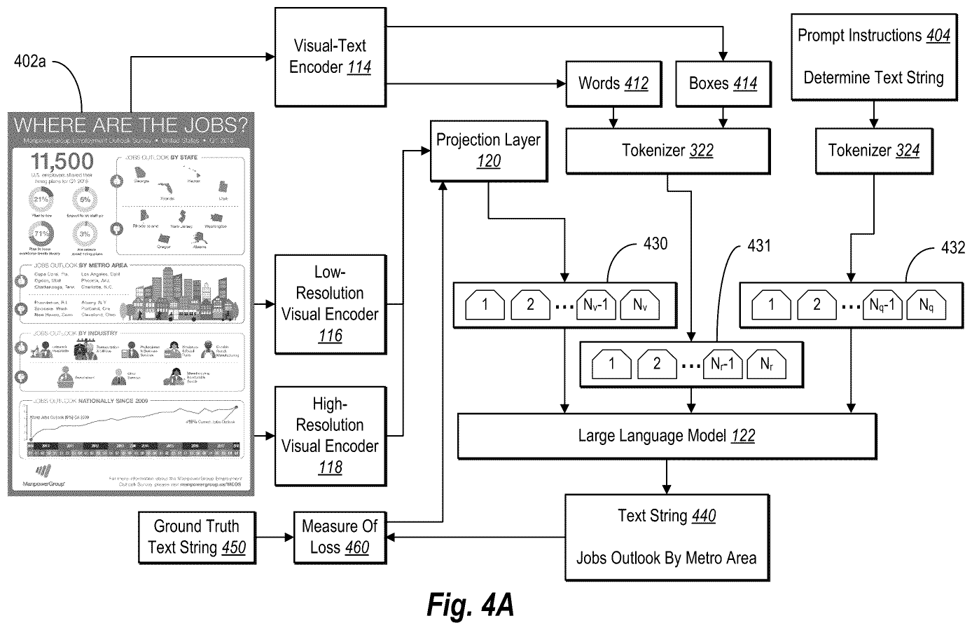

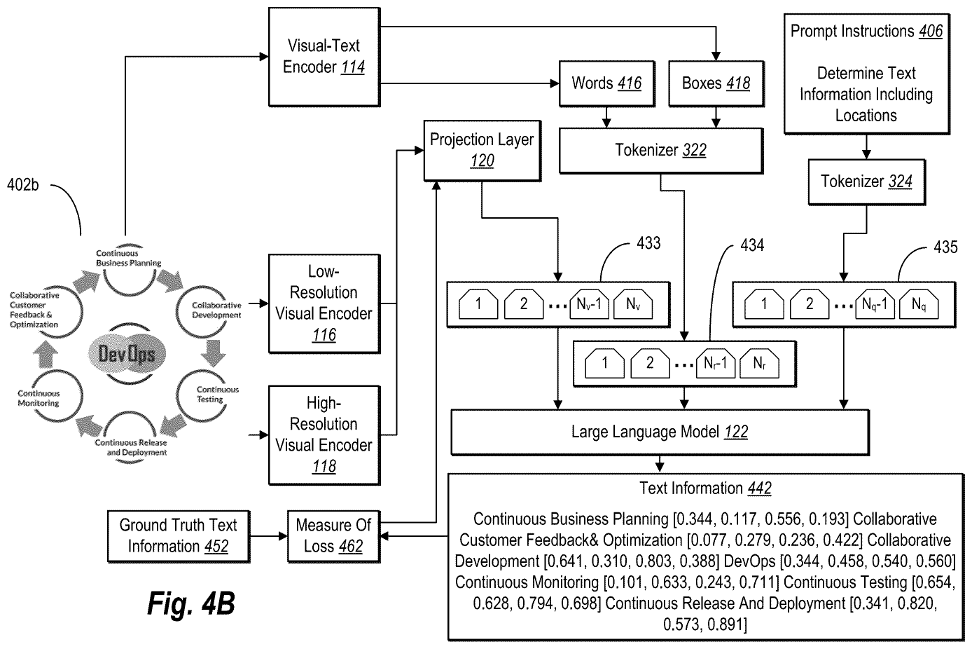

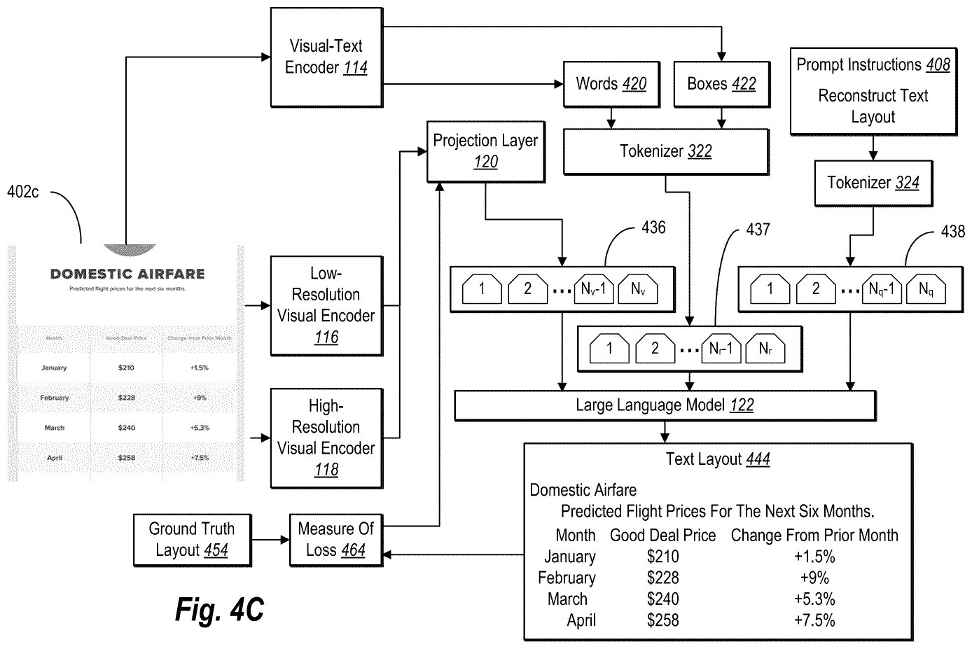

As mentioned above, in some embodiments, the multimodal reading system 102 trains one or more machine learning models. For instance, FIG. 4A-4C illustrate the multimodal reading system 102 pretraining the projection layer 120 in accordance with one or more embodiments. In particular, FIG. 4A shows the multimodal reading system 102 pretraining the projection layer 120 using a text recognition task, FIG. 4B shows the multimodal reading system 102 pretraining the projection layer 120 using a text localization task, and FIG. 4C shows the multimodal reading system 102 pretraining the projection layer 120 using page parsing and layout recovery tasks. For example, the multimodal reading system 102 pretrains the projection layer 120 for feature alignment to reduce or minimize a loss of text layout information.

To illustrate, FIG. 4A shows the multimodal reading system 102 accessing a digital image 402a. Similar to the description above for FIG. 3, the multimodal reading system 102 determines words 412 and bounding boxes 414 for text of the digital image 402a using the visual-text encoder 114. The multimodal reading system 102 uses the tokenizer 322 to generate text tokens 431 from the words 412 and bounding boxes 414. Also similarly, the multimodal reading system 102 generates a first set of visual features of the digital image 402a using the low-resolution visual encoder 116 and a second set (e.g., at a higher resolution) of visual features of the digital image 402a using the high-resolution visual encoder 118. Further, the multimodal reading system 102 combines the first and second sets of visual features and generates visual tokens 430 for the digital image 402a using the projection layer 120 to transform the set of combined visual features.

To illustrate pretraining of the projection layer 120, FIG. 4A shows the multimodal reading system 102 accessing prompt instructions 404 to determine a text string for the digital image 402a. In some embodiments, the multimodal reading system 102 generates the prompt instructions 404. For example, the multimodal reading system 102 generates a prompt comprising instructions to determine a text string corresponding to the text within the digital image.

Again, similar to the description above for FIG. 3, in some implementations, the multimodal reading system 102 uses the tokenizer 324 to generate prompt tokens 432 from the prompt instructions 404. Moreover, the multimodal reading system 102 generates a text string from the prompt using the large language model 122. For example, the multimodal reading system 102 prompts the large language model 122 with the prompt tokens 432, the text tokens 431, and the visual tokens 430 to generate a text string 440 that corresponds (e.g., matches) to text within the digital image 402a.

As shown in FIG. 4A, the multimodal reading system 102 pretrains the projection layer 120 using a text recognition task. For example, the multimodal reading system 102 compares the text string 440 with a ground truth text string 450 for the text within the digital image 402a to determine a measure of loss 460. Furthermore, the multimodal reading system 102 adjusts parameters of the projection layer 120 to reduce the measure of loss 460 (e.g., in a subsequent training iteration). For instance, the multimodal reading system 102 modifies the parameters of the projection layer 120 according to an optimization routine (e.g., gradient descent) to reduce the measure of loss 460 as pretraining progresses.

In some implementations, the multimodal reading system 102 trains only the projection layer 120 during the pretraining stage (e.g., by keeping the parameters of the visual-text encoder 114, the low-resolution visual encoder 116, the high-resolution visual encoder 118, and the large language model 122 frozen during pretraining).

To further illustrate the text recognition pretraining task, in some embodiments, the multimodal reading system 102 extracts the visual texts (e.g., using the visual-text encoder 114) and concatenates all detected words to form a target text sequence. The multimodal reading system 102 generates single-turn conversations for the digital image 402a by randomly sampling an input instruction and using the recognized text sequence as the desired output response. In some cases, instruction-following data may be noisy due to varying performance of text recognition tools across different fonts and backgrounds.

As mentioned, FIG. 4B shows the multimodal reading system 102 pretraining the projection layer 120 using a text localization task. To illustrate, FIG. 4B shows the multimodal reading system 102 accessing a digital image 402b. Similar to the description above for FIGS. 3 and 4A, the multimodal reading system 102 determines words 416 and bounding boxes 418 for text of the digital image 402b using the visual-text encoder 114. The multimodal reading system 102 uses the tokenizer 322 to generate text tokens 434 from the words 416 and bounding boxes 418. Also similarly, the multimodal reading system 102 generates a first set of visual features of the digital image 402b using the low-resolution visual encoder 116 and a second set (e.g., at a higher resolution) of visual features of the digital image 402b using the high-resolution visual encoder 118. Further, the multimodal reading system 102 combines the first and second sets of visual features and generates visual tokens 433 for the digital image 402b using the projection layer 120 to transform the set of combined visual features.

To further illustrate pretraining of the projection layer 120, FIG. 4B shows the multimodal reading system 102 accessing prompt instructions 406 to determine text information, including text location information, for the digital image 402b. In some embodiments, the multimodal reading system 102 generates the prompt instructions 406. For example, the multimodal reading system 102 generates a prompt comprising instructions to determine text location information for the text within the digital image.

Again, similar to the description above for FIGS. 3 and 4A, in some implementations, the multimodal reading system 102 uses the tokenizer 324 to generate prompt tokens 435 from the prompt instructions 406. Moreover, the multimodal reading system 102 generates text information from the prompt using the large language model 122. For example, the multimodal reading system 102 prompts the large language model 122 with the prompt tokens 435, the text tokens 434, and the visual tokens 433 to generate text information 442. For instance, the text information 442 includes text location information that reflects positions of the text within the digital image 402b. In the example shown in FIG. 4B, the multimodal reading system 102 determines that the text string “Continuous Business Planning” has a bounding box with x and y max and min coordinates of [0.344, 0.117, 0.556, 0.193]. (These coordinates are float values representing the top-left and bottom-right vertices of the bounding box within the digital image 402b.) As shown in FIG. 4B, the multimodal reading system 102 pretrains the projection layer 120 using a text localization task. For example, the multimodal reading system 102 compares the text information 442 (such as the text location information) with ground truth text information 452 (such as ground truth text location information) for the text within the digital image 402b to determine a measure of loss 462. Furthermore, the multimodal reading system 102 adjusts parameters of the projection layer 120 to reduce the measure of loss 462 (e.g., in a subsequent training iteration).

To further illustrate the text localization pretraining task, in some embodiments, the multimodal reading system 102 extracts text information and generates single-turn conversations for the digital image 402b by randomly sampling an instruction to extract both texts and bounding boxes, and using the recognized text sequence along with its bounding boxes as the desired output response. In some embodiments, this training scheme is effective and allows the multimodal reading system 102 to develop grounding ability. Furthermore, in some embodiments, the multimodal reading system 102 determines integer values (e.g., pixel count coordinates) for bounding boxes and converts the integer values to float values (e.g., ranging from zero to one) in the digital image.

As mentioned, FIG. 4C shows the multimodal reading system 102 pretraining the projection layer 120 using page parsing and layout recovery tasks. To illustrate, FIG. 4C shows the multimodal reading system 102 accessing a digital image 402c. Similar to the description above for FIGS. 3, 4A, and 4B, the multimodal reading system 102 determines words 420 and bounding boxes 422 for text within the digital image 402c using the visual-text encoder 114. The multimodal reading system 102 uses the tokenizer 322 to generate text tokens 437 from the words 420 and bounding boxes 422. Also similarly, the multimodal reading system 102 generates a first set of visual features of the digital image 402c using the low-resolution visual encoder 116 and a second set (e.g., at a higher resolution) of visual features of the digital image 402c using the high-resolution visual encoder 118. Further, the multimodal reading system 102 combines the first and second sets of visual features and generates visual tokens 436 for the digital image 402c using the projection layer 120 to transform the set of combined visual features.

To further illustrate pretraining of the projection layer 120, FIG. 4C shows the multimodal reading system 102 accessing prompt instructions 408 to reconstruct a text layout for the digital image 402c. In some embodiments, the multimodal reading system 102 generates the prompt instructions 408. For example, the multimodal reading system 102 generates a prompt comprising instructions to reconstruct a layout of the text within the digital image.

Again, similar to the description above for FIGS. 3, 4A, and 4B, in some implementations, the multimodal reading system 102 uses the tokenizer 324 to generate prompt tokens 438 from the prompt instructions 408. Moreover, the multimodal reading system 102 generates a text layout from the prompt using the large language model 122. For example, the multimodal reading system 102 prompts the large language model 122 with the prompt tokens 438, the text tokens 437, and the visual tokens 436 to generate a text layout 444. For instance, the text layout 444 represents text strings placed in relative positions of the text of the digital image 402c. In the example shown in FIG. 4C, the multimodal reading system 102 parses the text of the digital image 402c and places the corresponding text strings in relative positions (e.g., from top to bottom, and tabbing horizontally to separate text from different columns within the digital image 402c).

As shown in FIG. 4C, the multimodal reading system 102 pretrains the projection layer 120 using page parsing and layout recovery tasks. For example, the multimodal reading system 102 compares the text layout 444 with a ground truth text layout 454 for the text within the digital image 402c to determine a measure of loss 464. Furthermore, the multimodal reading system 102 adjusts parameters of the projection layer 120 to reduce the measure of loss 464 (e.g., in a subsequent training iteration).

Moreover, in some embodiments, the multimodal reading system 102 generates a prompt comprising instructions to determine plain text and text location information for the text within the digital image 402c. The multimodal reading system 102 parses the digital image 402c to generate the plain text and the text location information from the prompt utilizing the large language model 122. In some embodiments, the multimodal reading system 102 determines a measure of loss by comparing the plain text with ground truth text for the text within the digital image 402c. Additionally, or alternatively, in some embodiments, the multimodal reading system 102 determines the measure of loss by comparing the text location information with ground truth text location information for the text within the digital image 402c. Moreover, the multimodal reading system 102 adjusts the parameters of the projection layer 120 to reduce the measure of loss (e.g., in a subsequent training iteration).

To further illustrate the page parsing pretraining task, in some embodiments, the multimodal reading system 102 uses a layout reconstruction module to parse both words and bounding boxes, incorporating placeholders and new-line characters to reconstruct the image layout. Furthermore, the multimodal reading system 102 parses tables within images by converting HTML codes to Markdown style. For chart parsing, the multimodal reading system 102 uses the source data to construct the corresponding Markdown codes.

Additionally, to further illustrate the layout recovery pretraining task, in some embodiments, the multimodal reading system 102 utilizes text recognition results (e.g., results from the text localization task described above, such as OCR results) and parses pages (e.g., as described just above) to build instruction tuning pairs. The multimodal reading system 102 thus learns to better comprehend text location coordinates and reconstruct a layout using visual-text results.

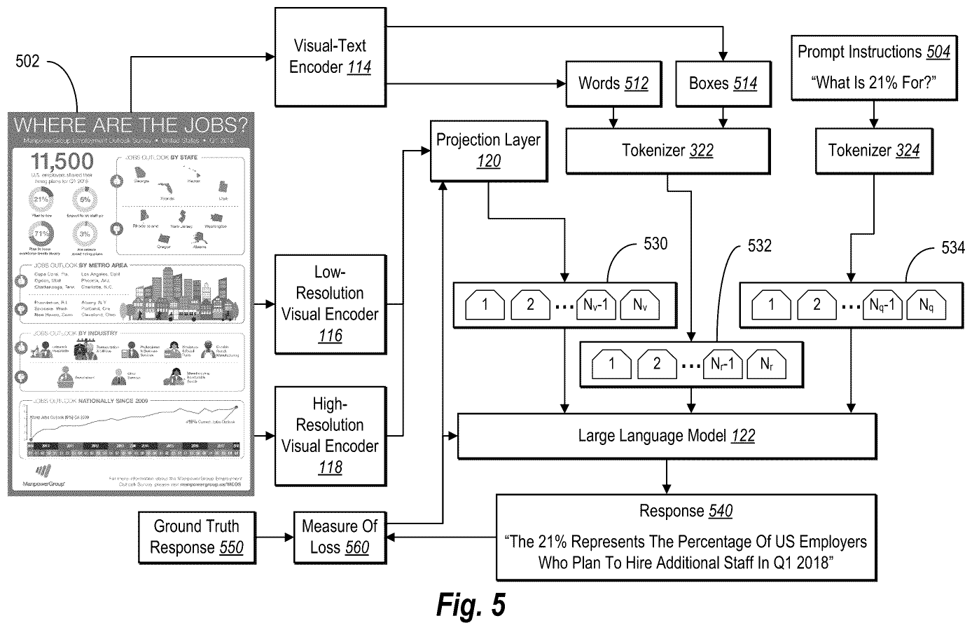

As discussed, in some embodiments, the multimodal reading system 102 finetunes one or more machine learning models. For instance, FIG. 5 illustrates the multimodal reading system 102 finetuning the projection layer 120 and the large language model 122 in accordance with one or more embodiments. For example, the multimodal reading system 102 finetunes the projection layer 120 and/or the large language model 122 to enhance understanding of visual texts for improved performance in following prompted instructions.

To illustrate, FIG. 5 shows the multimodal reading system 102 obtaining a digital image 502. Similar to the description above for FIGS. 3 and 4A-4C, the multimodal reading system 102 determines words 512 and bounding boxes 514 for text of the digital image 502 using the visual-text encoder 114. The multimodal reading system 102 uses the tokenizer 322 to generate text tokens 532 from the words 512 and bounding boxes 514. Also similarly, the multimodal reading system 102 generates a first set of visual features of the digital image 502 using the low-resolution visual encoder 116 and a second set (e.g., at a higher resolution) of visual features of the digital image 502 using the high-resolution visual encoder 118. Further, the multimodal reading system 102 combines the first and second sets of visual features and generates visual tokens 530 for the digital image 502 using the projection layer 120 to transform the set of combined visual features.

To illustrate finetuning of the projection layer 120 and the large language model 122, FIG. 5 shows the multimodal reading system 102 accessing prompt instructions 504 to generate a response to a query. In some embodiments, the multimodal reading system 102 uses the tokenizer 324 to generate query tokens 534 for the prompt instructions 504 (e.g., a query directed to the text of the digital image 502). Furthermore, in some embodiments, the multimodal reading system 102 generates the response to the query using the large language model 122. For example, the multimodal reading system 102 prompts the large language model 122 with the visual tokens 530, the text tokens 532, and the query tokens 534 to generate a response 540 for the query.

As mentioned, in some implementations, the multimodal reading system 102 fine tunes the projection layer 120 and/or the large language model 122 (e.g., while keeping the parameters of the visual-text encoder 114, the low-resolution visual encoder 116, and the high-resolution visual encoder 118 frozen). For example, the multimodal reading system 102 compares the response 540 with a ground truth response 550 for the query to determine a measure of loss 560. The multimodal reading system 102 adjusts parameters of the large language model 122 to reduce the measure of loss 560 (e.g., in a subsequent training iteration). For instance, the multimodal reading system 102 modifies the parameters of the large language model 122 according to an optimization routine (e.g., gradient descent) to reduce the measure of loss 560 as finetuning progresses.

Additionally, or alternatively, in some embodiments, the multimodal reading system 102 adjusts the parameters of the projection layer 120 to reduce the measure of loss 560. For example, the multimodal reading system 102 modifies the parameters of the projection layer 120 according to an optimization routine to reduce the measure of loss 560 as finetuning progresses.

To further illustrate the finetuning process, in some implementations, the multimodal reading system 102 uses a natural image finetuning dataset to improve understanding of visual texts and to align the encoders for text-rich image instruction tuning. In some embodiments, the multimodal reading system 102 utilizes visual question-answering datasets related to documents to enhance performance. Moreover, in some implementations, the multimodal reading system 102 trains on natural images with only visual tokens and query tokens (e.g., without text tokens). Additionally, in some implementations, the multimodal reading system 102 trains on text-rich images with the visual tokens, the text tokens, and the query tokens.

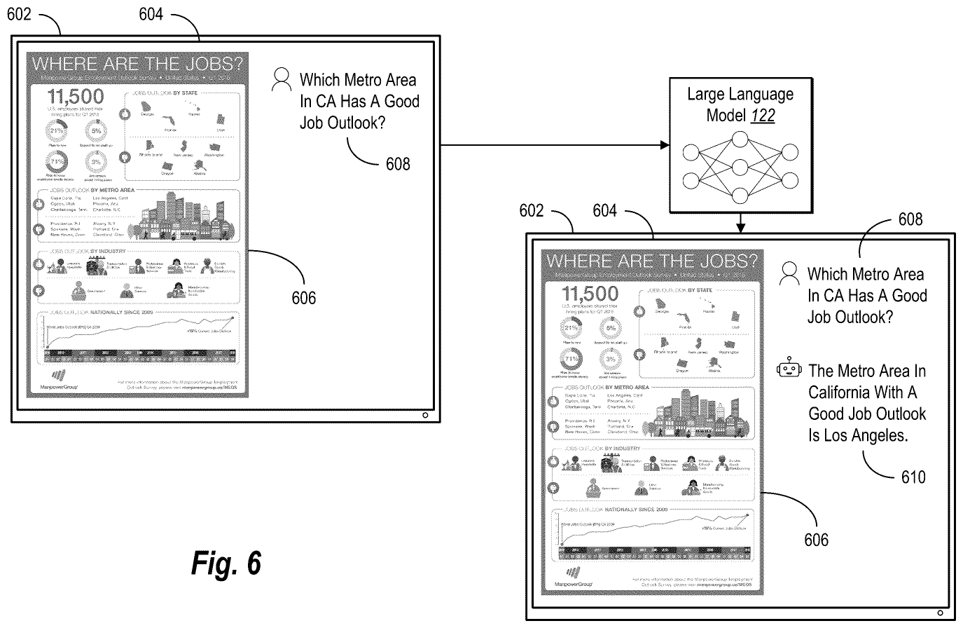

In some embodiments, the multimodal reading system 102 provides, for display via a graphical user interface, responses to queries directed to text within a digital image. For instance, FIG. 6 illustrates the multimodal reading system 102 reading a text-rich digital image and answering a question directed to the text of the digital image in accordance with one or more embodiments.

Specifically, FIG. 6 shows a computing device 602 (e.g., client device 108) with a graphical user interface 604. In some implementations, the multimodal reading system 102 provides, for display via the graphical user interface 604, an input digital image 606 and a user query 608. Moreover, FIG. 6 shows the multimodal reading system 102 generating a response 610 to the user query 608 using the machine learning models described herein. For example, the multimodal reading system 102 applies the techniques described above to generate the response 610 by prompting the large language model 122 with visual tokens and text tokens for the digital image 606 and query tokens for the user query 608. In addition, FIG. 6 shows the multimodal reading system 102 providing the response 610 for display via the graphical user interface 604.

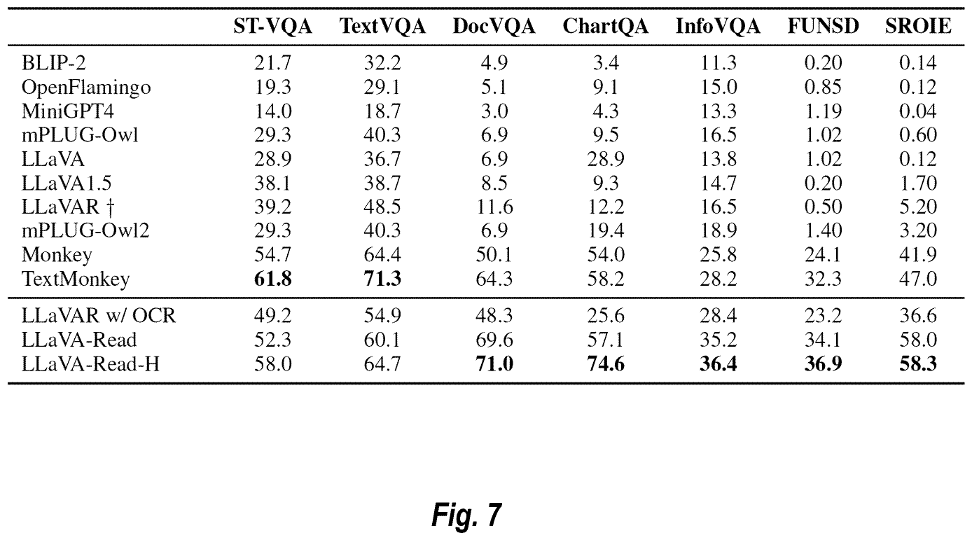

As discussed above, in some embodiments, the multimodal reading system 102 enhances reading ability of multimodal language models. For instance, FIG. 7 illustrates experimental results of the multimodal reading system 102, with comparisons to existing systems, in accordance with one or more embodiments.

Specifically, FIG. 7 shows a table of results of zero-shot performance on text-based visual question answering (VQA). The results are listed as accuracy percentages. The top ten rows show results for existing systems, while the bottom two rows show results for various embodiments of the multimodal reading system 102 (i.e., LLaVA-Read a multi-encoder architecture embodiment, and LLaVA-Read-H an embodiment that utilizes a higher resolution encoder). As demonstrated in the table, one or more implementations of the multimodal reading system 102 outperforms all ten existing systems in five of seven text-based question answering tasks and outperforms nine of the ten existing systems for the remaining two text-based question answering tasks. As discussed above, this enhanced reading performance is attributable at least in part to the architecture of the multimodal reading system 102 (including the visual-text encoder 114, the low-resolution visual encoder 116, the high-resolution visual encoder 118, the projection layer 120, and the large language model 122) as well as the training techniques described above (pretraining the projection layer 120 and finetuning the large language model 122 and the projection layer 120).

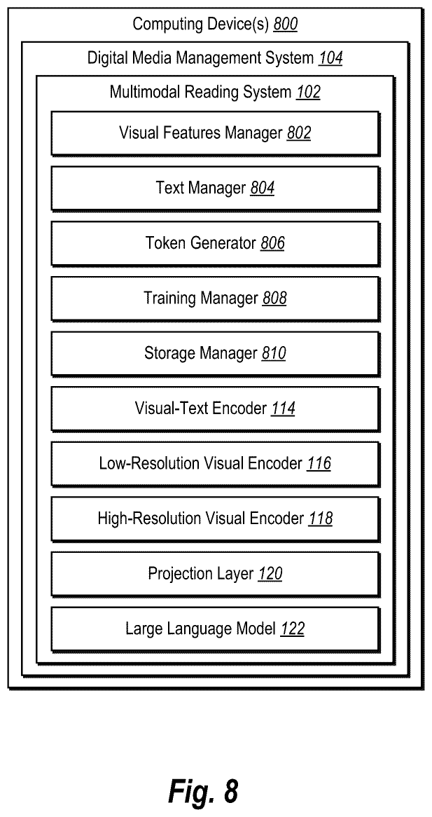

Turning now to FIG. 8, additional detail will be provided regarding components and capabilities of one or more embodiments of the multimodal reading system 102. In particular, FIG. 8 illustrates an example multimodal reading system 102 executed by a computing device(s) 800 (e.g., the server device(s) 106 or the client device 108). As shown by the embodiment of FIG. 8, the computing device(s) 800 includes or hosts the digital media management system 104 and/or the multimodal reading system 102. Furthermore, as shown in FIG. 8, the multimodal reading system 102 includes a visual features manager 802, a text manager 804, a token generator 806, a training manager 808, and a storage manager 810. Moreover, as described above, the multimodal reading system 102 includes the visual-text encoder 114, the low-resolution visual encoder 116, the high-resolution visual encoder 118, the projection layer 120, and the large language model 122.

As shown in FIG. 8, the multimodal reading system 102 includes a visual features manager 802. In some implementations, the visual features manager 802 generates high-resolution visual features and low-resolution visual features of a digital image. For example, as discussed in greater detail above, the visual features manager 802 utilizes the high-resolution visual encoder 118 and the low-resolution visual encoder 116 to generate the visual features.

In addition, as shown in FIG. 8, the multimodal reading system 102 includes a text manager 804. In some implementations, the text manager 804 determines textual information for a digital image. For instance, as discussed in greater detail above, the text manager 804 determines a text string and text location information corresponding to text within the digital image. To illustrate, the text manager 804 utilizes the visual-text encoder to determine the textual information.

Moreover, as shown in FIG. 8, the multimodal reading system 102 includes a token generator 806. In some implementations, the token generator 806 generates visual tokens, text tokens, and/or query tokens. For instance, as discussed in greater detail above, the token generator 806 utilizes the projection layer 120 to generate visual tokens from the visual features. Additionally, in some implementations, the token generator 806 uses a tokenizer to generate text tokens from text information and query tokens from a user query.

Furthermore, as shown in FIG. 8, the multimodal reading system 102 includes a training manager 808. In some implementations, as discussed in greater detail above, the training manager 808 trains (e.g., modifies parameters of) one or more machine learning models, as described above, including the projection layer 120, and the large language model 122. For example, in some implementations the training manager 808 pretrains the projection layer 120. Likewise, in some implementations, the training manager 808 finetunes the projection layer 120 and/or the large language model 122.

Additionally, as shown in FIG. 8, the multimodal reading system 102 includes a storage manager 810. In some implementations, the storage manager 810 stores information (e.g., via one or more memory devices) on behalf of the multimodal reading system 102. For example, the storage manager 810 stores digital images, user queries, textual information, text tokens, visual tokens, query tokens, responses, and/or parameters of the visual-text encoder 114, the low-resolution visual encoder 116, the high-resolution visual encoder 118, the projection layer 120, and the large language model 122.

Each of the components 802-810 of the multimodal reading system 102 includes software, hardware, or both. For example, the components 802-810 include one or more instructions stored on a computer-readable storage medium and executable by processors of one or more computing devices, such as a client device or server device. When executed by the one or more processors, in some implementations, the computer-executable instructions of the multimodal reading system 102 cause the computing device(s) to perform the methods described herein. Alternatively, in one or more implementations, the components 802-810 include hardware, such as a special purpose processing device to perform a certain function or group of functions. Alternatively, in some implementations, the components 802-810 of the multimodal reading system 102 include a combination of computer-executable instructions and hardware.

Furthermore, the components 802-810 of the multimodal reading system 102 are, for example, implemented as one or more operating systems, as one or more stand-alone applications, as one or more modules of an application, as one or more plug-ins, as one or more library functions, as one or more functions callable by other applications, and/or as a cloud-computing model. Thus, in some implementations, the components 802-810 are implemented as a stand-alone application, such as a desktop or mobile application. Furthermore, in various implementations, the components 802-810 are implemented as one or more web-based applications hosted on a remote server. In some implementations, the components 802-810 are implemented in a suite of mobile device applications or “apps. ” To illustrate, in some implementations, the components 802-810 are implemented in an application, including but not limited to Adobe Acrobat, Adobe Creative Cloud, Adobe Express, Adobe Firefly, and Adobe Photoshop. The foregoing are either registered trademarks or trademarks of Adobe in the United States and/or other countries.

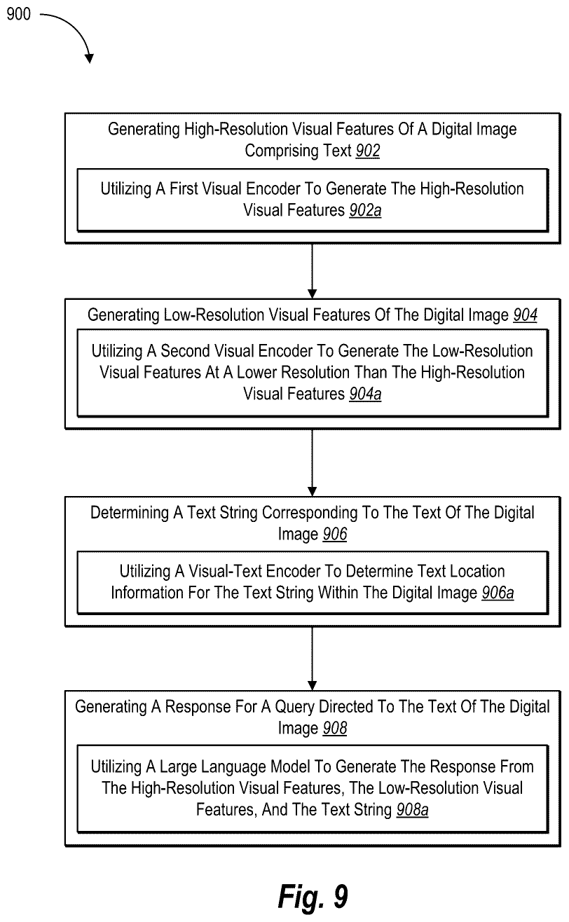

FIG. 1-8, the corresponding text, and the examples provide a number of different methods, systems, devices, and non-transitory computer-readable media of the multimodal reading system 102. In addition to the foregoing, one or more embodiments are described in terms of flowcharts comprising acts for accomplishing a particular result, as shown in FIG. 9. In some implementations, the processes of the multimodal reading system 102 are performed with more or fewer acts. Furthermore, in various implementations, the acts are performed in differing orders. Additionally, in some implementations, the acts described herein are repeated or performed in parallel with one another or in parallel with different instances of the same or similar acts.

As mentioned, FIG. 9 illustrates a flowchart of a series of acts 900 for reading text within a digital image and generating a response to a query directed to the text within the digital image in accordance with one or more implementations. While FIG. 9 illustrates acts according to one implementation, alternative implementations omit, add to, reorder, and/or modify any of the acts shown in FIG. 9. In one or more implementations, the acts of FIG. 9 are performed as part of a method (e.g., a computer-implemented method). Alternatively, in one or more implementations, a non-transitory computer-readable storage medium comprises instructions that, when executed by one or more processors, cause a computing device to perform the acts of FIG. 9. In some implementations, a system performs the acts of FIG. 9.

As shown in FIG. 9, the series of acts 900 includes an act 902 of generating high-resolution visual features of a digital image comprising text, an act 904 of generating low-resolution visual features of the digital image, an act 906 of determining a text string corresponding to the text of the digital image, and an act 908 of generating a response for a query directed to the text of the digital image. As also shown in FIG. 9, the series of acts 900 includes an act 902a of utilizing a first visual encoder to generate the high-resolution visual features, an act 904a of utilizing a second visual encoder to generate the low-resolution visual features at a lower resolution than the high-resolution visual features, an act 906a of utilizing a visual-text encoder to determine text location information for the text string within the digital image, and an act 908a of utilizing a large language model to generate the response from the high-resolution visual features, the low-resolution visual features, and the text string.

In particular, in some implementations, the act 902 includes generating, utilizing a first visual encoder, a first set of visual features of a digital image comprising text, the act 904 includes generating, utilizing a second visual encoder, a second set of visual features of the digital image, the act 906 includes determining, utilizing a visual-text encoder, a text string corresponding to the text of the digital image, and the act 908 includes generating, for a query directed to the text of the digital image, a response from the first set of visual features, the second set of visual features, and the text string utilizing a large language model.

For example, in some implementations, the series of acts 900 includes generating the second set of visual features by generating visual features that have a lower resolution than the first set of visual features. Moreover, in some implementations, the series of acts 900 includes determining, utilizing the visual-text encoder, text location information for the text string within the digital image. In some implementations, the series of acts 900 includes generating the response from the first set of visual features, the second set of visual features, the text string, and the text location information utilizing the large language model. Furthermore, in some implementations, the series of acts 900 includes generating the response by prompting the large language model with tokens for the first set of visual features, the second set of visual features, the text string, and the query.

Additionally, in some implementations, the series of acts 900 includes combining the first set of visual features and the second set of visual features into a set of combined visual features for the digital image. In some implementations, the series of acts 900 includes generating, utilizing a projection layer to transform the set of combined visual features, visual tokens for the digital image. Moreover, in some implementations, the series of acts 900 includes generating, utilizing a text tokenizer, text tokens for the text of the digital image. In some implementations, the series of acts 900 includes generating, utilizing the text tokenizer, query tokens for the query directed to the text of the digital image. Furthermore, in some implementations, the series of acts 900 includes generating the response by prompting the large language model with the visual tokens, the text tokens, and the query tokens to generate the response for the query.

In addition, in some implementations, the series of acts 900 includes generating, utilizing a first visual encoder, low-resolution visual features of a digital image; generating, utilizing a second visual encoder, high-resolution visual features of the digital image, wherein the high-resolution visual features have a higher resolution than the low-resolution visual features; combining the high-resolution visual features and the low-resolution visual features into a set of combined visual features for the digital image; generating, utilizing a projection layer, visual tokens from the set of combined visual features for the digital image; and generating, for a query directed to text within the digital image, a response based on the visual tokens.

Moreover, in some implementations, the series of acts 900 includes generating a prompt comprising instructions to determine a text string corresponding to the text within the digital image; generating the text string from the prompt utilizing a large language model; and adjusting parameters of the projection layer to reduce a measure of loss determined by comparing the text string with a ground truth text string for the text within the digital image.

Furthermore, in some implementations, the series of acts 900 includes generating a prompt comprising instructions to determine text location information for the text within the digital image; generating the text location information from the prompt utilizing a large language model; and adjusting parameters of the projection layer to reduce a measure of loss determined by comparing the text location information with ground truth text location information for the text within the digital image.

Additionally, in some implementations, the series of acts 900 includes generating a prompt comprising instructions to determine plain text and text location information for the text within the digital image; parsing the digital image to generate the plain text and the text location information from the prompt utilizing a large language model; and adjusting parameters of the projection layer to reduce a measure of loss determined by: comparing the plain text with ground truth text for the text within the digital image; and comparing the text location information with ground truth text location information for the text within the digital image.

Moreover, in some implementations, the series of acts 900 includes generating a prompt comprising instructions to reconstruct a layout of the text within the digital image; generating a textual layout of the text within the digital image from the prompt utilizing a large language model; and adjusting parameters of the projection layer to reduce a measure of loss determined by comparing the textual layout with a ground truth layout for the text within the digital image.

Furthermore, in some implementations, the series of acts 900 includes determining, utilizing a visual-text encoder, a text string and text location information corresponding to the text within the digital image; and generating the response based on the visual tokens, the text string, the text location information, and the query. Moreover, in some implementations, the series of acts 900 includes generating the response by prompting a large language model with the visual tokens and tokens for the query.

In addition, in some implementations, the series of acts 900 includes generating, utilizing a high-resolution visual encoder and a low-resolution visual encoder, a set of visual features for a digital image; generating, utilizing a projection layer, visual tokens from the set of visual features for the digital image; determining, utilizing a visual-text encoder to extract text information from the digital image, a text string identifying text within the digital image; and generating, utilizing a large language model, a response for a query directed to the text based on the visual tokens.

Moreover, in some implementations, the series of acts 900 includes generating the response for the query utilizing the large language model from the visual tokens and tokens for the query; and adjusting parameters of the large language model to reduce a measure of loss determined by comparing the response with a ground truth response for the query. Furthermore, in some implementations, the series of acts 900 includes generating, from the text information, text tokens for the text string identifying the text within the digital image; and generating, utilizing the large language model, the response for the query from the text tokens. Additionally, in some implementations, the series of acts 900 includes adjusting parameters of the projection layer to reduce the measure of loss determined by comparing the response with the ground truth response for the query.

Moreover, in some implementations, the series of acts 900 includes generating the set of visual features by: utilizing the high-resolution visual encoder to generate high-resolution visual features for the digital image; utilizing the low-resolution visual encoder to generate low-resolution visual features for the digital image at a lower resolution than the high-resolution visual features; and combining the high-resolution visual features and the low-resolution visual features into a set of combined visual features for the digital image. Furthermore, in some implementations, the series of acts 900 includes determining, utilizing the visual-text encoder, text location information for the text string identifying the text within the digital image; and generating, utilizing the large language model, the response for the query from text tokens for the text string and the text location information.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000, may represent the computing devices described above (e.g., the computing device(s) 800, the server device(s) 106, or the client device 108). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes the memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes the storage device 1006 for storing data or instructions. As an example, and not by way of limitation, the storage device 1006 can include a non-transitory storage medium described above. The storage device 1006 may include a hard disk drive (“HDD”), flash memory, a Universal Serial Bus (“USB”) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (“NIC”) or network adapter for communicating with an Ethernet or other wire-based network or a wireless NIC (“WNIC”) or wireless adapter for communicating with a wireless network, such as a WI-FI. The computing device 1000 can further include the bus 1012. The bus 1012 can include hardware, software, or both that connects components of computing device 1000 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a first visual encoder, a first set of visual features of a digital image comprising text;
generating, utilizing a second visual encoder, a second set of visual features of the digital image;
determining, utilizing a visual-text encoder, a text string corresponding to the text of the digital image; and
generating, for a query directed to the text of the digital image, a response from the first set of visual features, the second set of visual features, and the text string utilizing a large language model.

2. The computer-implemented method of claim 1, wherein generating the second set of visual features comprises generating visual features that have a lower resolution than the first set of visual features.

3. The computer-implemented method of claim 1, further comprising:
determining, utilizing the visual-text encoder, text location information for the text string within the digital image; and
generating the response from the first set of visual features, the second set of visual features, the text string, and the text location information utilizing the large language model.

4. The computer-implemented method of claim 1, wherein generating the response comprises prompting the large language model with tokens for the first set of visual features, the second set of visual features, the text string, and the query.

5. The computer-implemented method of claim 1, further comprising:
combining the first set of visual features and the second set of visual features into a set of combined visual features for the digital image; and
generating, utilizing a projection layer to transform the set of combined visual features, visual tokens for the digital image.

6. The computer-implemented method of claim 5, further comprising:
generating, utilizing a text tokenizer, text tokens for the text of the digital image; and
generating, utilizing the text tokenizer, query tokens for the query directed to the text of the digital image.

7. The computer-implemented method of claim 6, wherein generating the response comprises prompting the large language model with the visual tokens, the text tokens, and the query tokens to generate the response for the query.

8. A system comprising:
a memory component; and
one or more processing devices coupled to the memory component, the one or more processing devices to perform operations comprising:
generating, utilizing a first visual encoder, low-resolution visual features of a digital image;
generating, utilizing a second visual encoder, high-resolution visual features of the digital image, wherein the high-resolution visual features have a higher resolution than the low-resolution visual features;
combining the high-resolution visual features and the low-resolution visual features into a set of combined visual features for the digital image;
generating, utilizing a projection layer, visual tokens from the set of combined visual features for the digital image; and
generating, for a query directed to text within the digital image, a response based on the visual tokens.

9. The system of claim 8, wherein the operations further comprise:
generating a prompt comprising instructions to determine a text string corresponding to the text within the digital image;
generating the text string from the prompt utilizing a large language model; and
adjusting parameters of the projection layer to reduce a measure of loss determined by comparing the text string with a ground truth text string for the text within the digital image.

10. The system of claim 8, wherein the operations further comprise:
generating a prompt comprising instructions to determine text location information for the text within the digital image;
generating the text location information from the prompt utilizing a large language model; and
adjusting parameters of the projection layer to reduce a measure of loss determined by comparing the text location information with ground truth text location information for the text within the digital image.

11. The system of claim 8, wherein the operations further comprise:
generating a prompt comprising instructions to determine plain text and text location information for the text within the digital image;
parsing the digital image to generate the plain text and the text location information from the prompt utilizing a large language model; and
adjusting parameters of the projection layer to reduce a measure of loss determined by:
comparing the plain text with ground truth text for the text within the digital image; and
comparing the text location information with ground truth text location information for the text within the digital image.

12. The system of claim 8, wherein the operations further comprise:
generating a prompt comprising instructions to reconstruct a layout of the text within the digital image;
generating a textual layout of the text within the digital image from the prompt utilizing a large language model; and
adjusting parameters of the projection layer to reduce a measure of loss determined by comparing the textual layout with a ground truth layout for the text within the digital image.

13. The system of claim 8, wherein the operations further comprise:
determining, utilizing a visual-text encoder, a text string and text location information corresponding to the text within the digital image; and
generating the response based on the visual tokens, the text string, the text location information, and the query.

14. The system of claim 8, wherein generating the response comprises prompting a large language model with the visual tokens and tokens for the query.

15. A non-transitory computer-readable medium storing executable instructions that, when executed by a processing device, cause the processing device to perform operations comprising:
generating, utilizing a high-resolution visual encoder and a low-resolution visual encoder, a set of visual features for a digital image;
generating, utilizing a projection layer, visual tokens from the set of visual features for the digital image;
determining, utilizing a visual-text encoder to extract text information from the digital image, a text string identifying text within the digital image; and
generating, utilizing a large language model, a response for a query directed to the text based on the visual tokens.

16. The non-transitory computer-readable medium of claim 15, wherein the operations further comprise:
generating the response for the query utilizing the large language model from the visual tokens and tokens for the query; and
adjusting parameters of the large language model to reduce a measure of loss determined by comparing the response with a ground truth response for the query.

17. The non-transitory computer-readable medium of claim 16, wherein the operations further comprise:
generating, from the text information, text tokens for the text string identifying the text within the digital image; and
generating, utilizing the large language model, the response for the query from the text tokens.

18. The non-transitory computer-readable medium of claim 16, wherein the operations further comprise adjusting parameters of the projection layer to reduce the measure of loss determined by comparing the response with the ground truth response for the query.

19. The non-transitory computer-readable medium of claim 15, wherein generating the set of visual features comprises:
utilizing the high-resolution visual encoder to generate high-resolution visual features for the digital image;
utilizing the low-resolution visual encoder to generate low-resolution visual features for the digital image at a lower resolution than the high-resolution visual features; and
combining the high-resolution visual features and the low-resolution visual features into a set of combined visual features for the digital image.

20. The non-transitory computer-readable medium of claim 15, wherein the operations further comprise:
determining, utilizing the visual-text encoder, text location information for the text string identifying the text within the digital image; and
generating, utilizing the large language model, the response for the query from text tokens for the text string and the text location information.
